(19) United States
(12) Patent Application Publication
(10) Pub. No.: US 2018/0189288 A1
(43) Pub. Date: Jul. 5, 2018

(54) QUALITY INDUSTRY CONTENT MIXED WITH FRIEND'S POSTS IN SOCIAL NETWORK

(71) Applicant: Microsoft Technology Licensing, LLC, Redmond, WA (US)

(72) Inventors: Liang Zhang, Fremont, CA (US); Lin Zhu, Beijing (CN); Di Wang, Beijing (CN); Sheng Zhao, Beijing (CN); Yang Liu, Beijing (CN); Shu Chen, Beijing (CN)

(21) Appl. No.: 15/125,782

(22) PCT Filed: Aug. 1, 2016
(86) PCT No.: PCT/CN2016/092667

§ 371 Date: Sep. 13, 2016

(51) Int. Cl. G06F 17/30; G06Q 50/00; G06F 15/18; G06K 9/62

(52) U.S. Cl. CPC G06F 17/3053; G06Q 50/01; G06K 9/6223; G06F 15/18; G06F 17/30867

(57) ABSTRACT

Methods, systems, and programs are provided for presenting professional content in a user feed. The user feed is populated with industry-wise content, using relevance-driven technologies to select the best relevant industry content, while solving the problem of low-content availability for users with few connections. Professional posts created by users in a social network are identified, where each user is associated with an industry as configured in a profile of the user. A score for each identified professional post is calculated and the professional posts are sorted based on their scores. After detecting a request for data to present in a first user feed to a first user that is associated with a first industry, the server selects professional posts based on the industry of the user that created each post. The selected professional posts are then merged with other types of content and presented in the first user feed.

### TECHNICAL FIELD

The subject matter disclosed herein generally relates to methods, systems, and programs for ranking content in a social network and, more particularly, methods, systems, and computer programs for selecting content for posting in a user feed of a social network.

### BACKGROUND

Social networks often provide a large amount of content for presentation to a user in what is commonly referred to as the user feed. The interest of the user in the user feed depends mostly on the quality of the content: if the content is not interesting, the user will abandon the social network, but if the content is interesting, the user will continue accessing the user feed.

When a user first joins the social network, the user may have few, or none, social connections on the social network, and if the social network only presents friend's posts on the user feed, the feed may be almost empty. An empty feed means boredom and lack of interest by the user, which may decide to quit the social network.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIGS. 2A and 2B are screenshots of a user interface that includes a user feed on a social website, according to some example embodiments.

FIG. 3 is a screenshot of a user's profile view, according to some example embodiments.

FIG. 4 is a diagram illustrating the creation of the user feed by merging a plurality of content types, according to some example embodiments.

FIG. 5 is a diagram illustrating the friend model, according to some example embodiments.

FIG. 6 illustrates the click-through rate (CTR) model, according to some example embodiments.

FIG. 7 illustrates the tracking of the CTR, according to some example embodiments.

FIG. 8 is a diagram illustrating a method for training a classifier, according to some example embodiments.

FIG. 9 is a diagram illustrating the assignment of a post to a cluster, according to one example embodiment.

FIG. 10 illustrates a social networking server that provides access to user feeds, according to one example embodiment.

FIG. 11 is a flowchart of a method, according to some example embodiments, for presenting professional content in a user feed of a social network.

FIG. 12 is a block diagram illustrating an example of a software architecture that may be installed on a machine, according to some example embodiments.

FIG. 13 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are presented for optimizing the content of a user feed that includes professional and nonprofessional posts. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some example embodiments, a user feed in a social website includes professional content, related to the professional activities of the user, mixed with other types of content, such as content created by friends, companies, authorities being followed by the user, the editor's picks, and so forth. The content is provided by other users of the social network, and the system determines if each post is considered professional or nonprofessional content by utilizing machine-learning techniques to train a classifier to automatically determine the type of the post.

When a new user joins a social network, the user does not have many friends or social network connections. Therefore, the content presented on the user feed may not be of interest to the user. In one example embodiment, a social network is oriented towards professional activities, although other nonprofessional activities are also included. In order to present content of interest to the new user, the social network identifies professional content related to the industry of the user and selects the best posts from the same industry to be included in the user feed. Several machine-learning algorithms are utilized to predict the value (e.g., score) of posts, as well as to determine the kind of posts available for presentation (e.g., professional posts, friend's posts).

One general aspect includes a method including an operation for identifying, by a server that includes a processor, a plurality of professional posts created by users in a social network, with each user being associated with an industry from a plurality of industries as configured in a profile of the user. The method also includes calculating, by the server, a score for each identified professional post, and sorting the plurality of professional posts based on the scores. In some example embodiments, the professional posts do not include the posts created by the user's connections and do not include the posts created by other entities that the user follows (e.g., topics or companies). In other example embodiments, the professional posts may also include posts from friends or entities followed if they are in the same industry as the user.

The method further includes an operation for detecting, by the server, a request for data to present a first user feed to a first user that is associated with a first industry. The method also includes selecting, by the server, one or more professional posts based on the industry of the user that created each post, and presenting the selected one or more professional posts in the first user feed.

One general aspect includes a server including a memory having instructions, and one or more computer processors. The instructions, when executed by the one or more computer processors, cause the one or more computer processors to perform operations including identifying a plurality of professional posts created by users in a social network, with each user being associated with an industry from a plurality of industries as configured in a profile of the user; calculating a score for each identified professional post and sorting the plurality of professional posts based on the scores; detecting a request for data to present a first user feed to a first user that is associated with a first industry; selecting one or more professional posts based on the industry of the user that created each post; and causing the selected one or more professional posts to be presented in the first user feed.

One general aspect includes a non-transitory machine-readable storage medium including instructions that, when executed by a machine, cause the machine to perform operations including identifying a plurality of professional posts created by users in a social network, with each user being associated with an industry from a plurality of industries as configured in a profile of the user; calculating a score for each identified professional post and sorting the plurality of professional posts based on the scores; detecting a request for data to present a first user feed to a first user that is associated with a first industry; selecting one or more professional posts based on the industry of the user that created each post; and causing the selected one or more professional posts to be presented in the first user feed.

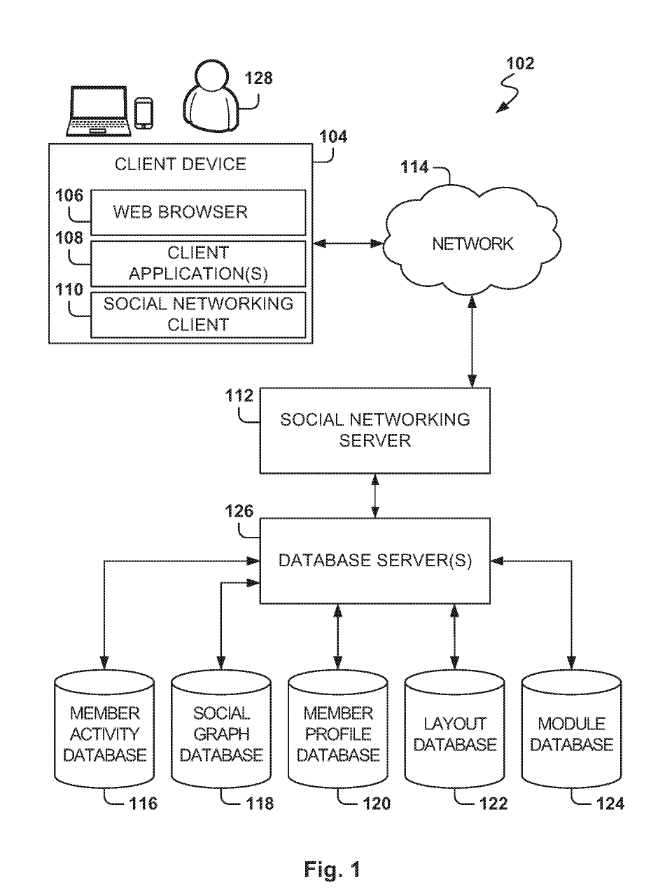

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106 (e.g., the Internet Explorer® browser developed by Microsoft® Corporation), client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, an ultra book, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access to member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a layout database 122, and a module database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry, skills, professional organizations, and so on. This information is stored, for example, in the member profile database 120. Similarly, when a representative of an organization initially registers the organization with the social networking service provided by the social networking server 112, the representative may be prompted to provide certain information about the organization. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The layout database 122 stores one or more layout configuration files for defining the layout of a corresponding webpage. In one embodiment, a layout configuration file defines the portions and/or sections of a webpage according to the type and/or substance of content that is to appear in each defined portion and/or section of the webpage. In this manner, one or more webpages provided by the social networking server 112 may each be associated with a corresponding layout configuration file. Alternatively and/or additionally, a layout configuration file corresponds to more than one webpage.

The module database 124 provides access to one or more modules, which may be retrieved by the social networking server 112 and communicated to the client device 104. The modules stored within the module database 124 provide various functionalities and features for engaging with the social networking service provided by the social networking server 112. In one embodiment, the modules stored within the module database 124 are designed to provide a given feature or functionality. For example, the module database 124 may include a module that provides updates about a member's connections, a module that facilitates the uploading and/or editing of a member's profile selected from the member profile database 120, a module that retrieves news or other items of interest for a member's profile, a module that facilitates searching for content provided by the social networking server 112, and other such modules. In summary, the modules stored in the module database 124 may provide one or more functionalities that enhance a member's experience with the social networking service.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

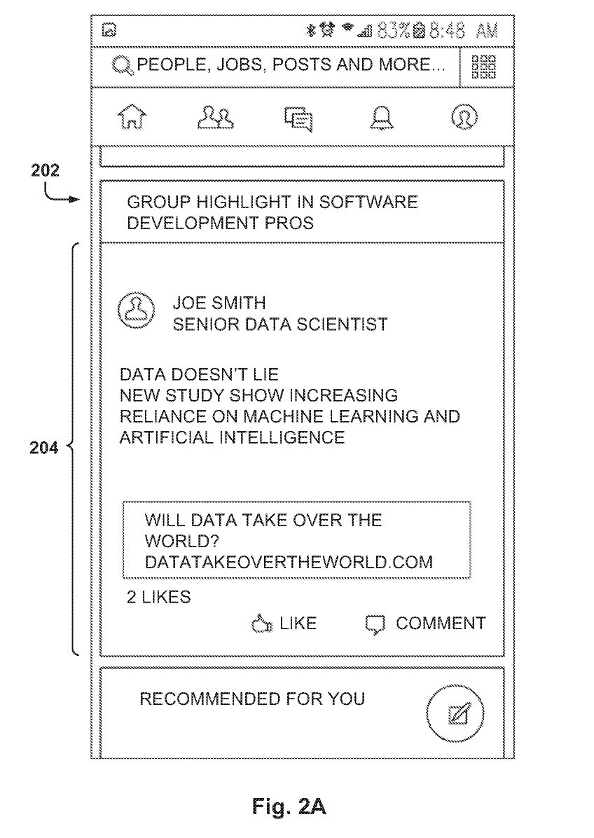

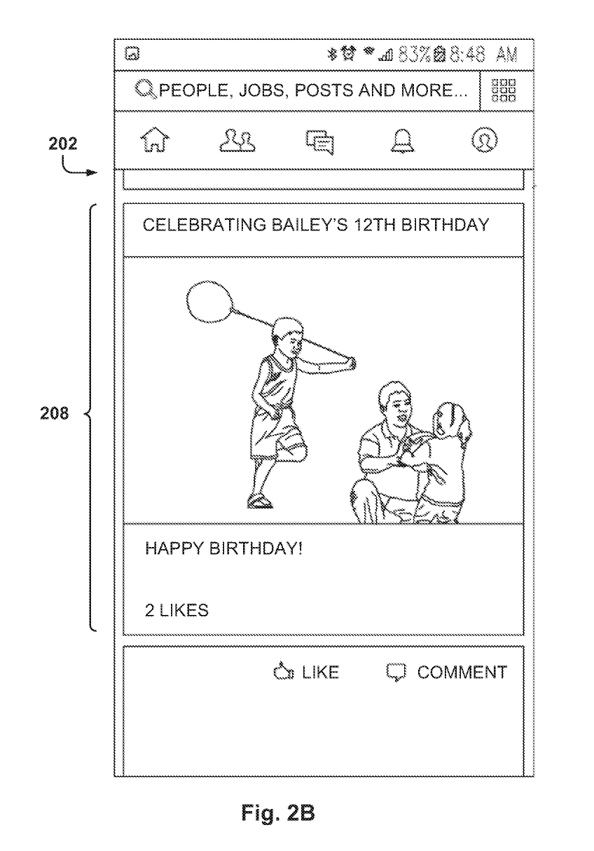

FIGS. 2A and 2B are screenshots of a user interface that includes a user feed 202 on a social website, according to some example embodiments. In one example embodiment, the user feed 202 includes one or more user posts 204, 208. As the user scrolls down the user feed 202, more posts are presented to the user. In some example embodiments, the posts are prioritized to present posts in an estimated order of interest to the user.

In one example embodiment, the posts are classified into one of a professional post (e.g., post 204) or a nonprofessional post (e.g., 208). The professional posts are associated with a professional activity of the user, while the nonprofessional posts are related to the social activity of the user on the social network. A professional activity relates to an action of the user that is associated with the user's job. If the user works for a for-profit organization, the activity relates to a business purpose or a commercial purpose. If the user's job is a government job, the professional activity may include government activities related to the user's job. If the user works for a non-profit organization, the professional activity may include actions related to the non-profit organization. The criteria to prioritize professional and nonprofessional posts are different because of the different nature of the posts. For example, a nonprofessional post may be ranked high if the poster has a close relationship to the user, but a professional post may be ranked high even if the poster does not have a close relationship to the user, for example, if the poster is a recognized authority in the profession of the user.

In some example embodiments of the user feed 202, the social network determines how to sort the professional and nonprofessional posts according to multiple criteria. For example, some users may be more interested in professional content while other uses may be more interested in nonprofessional content. Further, the social network decides how to sort professional posts by estimating which ones will be of higher interest to the user.

When a user first joins the social network, the user may not have many user connections on the social network. Therefore, it is important to provide professional content that is of high interest to the user in order to increase the participation of the user in the social network, and so that the user can continue adding new connections and provide content for other users.

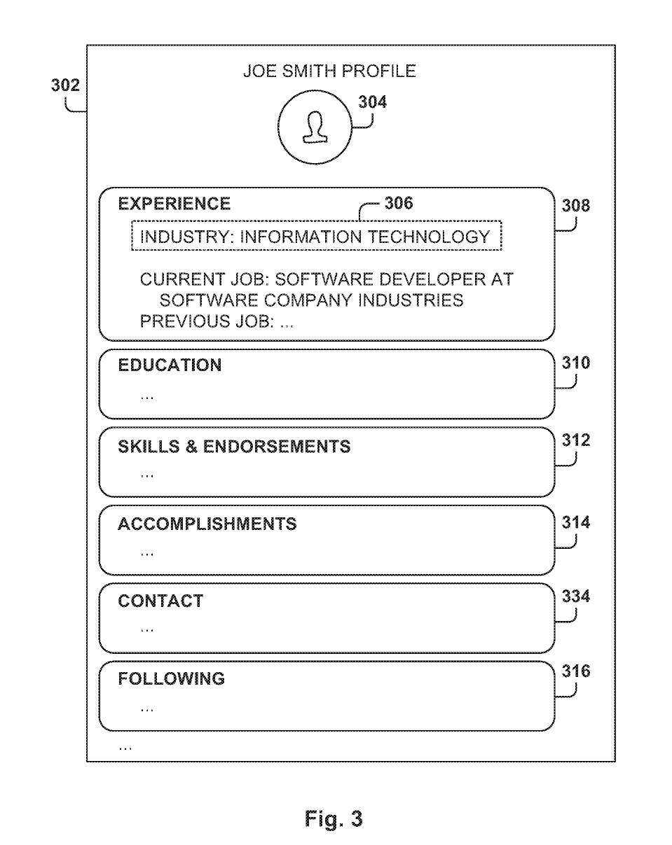

FIG. 3 is a screenshot of a user's profile view, according to some example embodiments. Each user in the social network has a user profile 302, which includes information about the user. The user profile is configurable by the user and also includes information based on the user activity in the social network (e.g., likes, posts read).

In one example embodiment, the user profile may include information in several categories, such as experience 308, education 310, skills and endorsements 312, accomplishment 314, contact information 334, following 316, and the like.

The experience 308 information includes information related to the professional experience of the user. In one example embodiment, the experience 308 information includes an industry 306, which identifies the industry in which the user works. In one example embodiment, the user is given an option to select an industry from a plurality of industries when entering this value in the profile. In other example embodiments, the user may also enter an industry that is not in the list of predefined industries. In some example embodiments, the industry is defined at a high level. Some examples of industries configurable in the user profile include information technology, mechanical engineering, marketing, and the like. The user's profile is identified as associated with a particular industry and the posts related to that particular industry are considered for inclusion in the user's feed, even if the posts do not originate from the user's connections or from other types of entities that the user explicitly follows.

The experience 308 information area may also include information about the current job and previous jobs held by the user. The education 310 includes information about the educational background of the user. The skills and endorsements 312 includes information about professional skills that the user has identified as having been acquired by the user, and endorsements entered by other users of the social network supporting the skills of the user. The accomplishments 314 area includes accomplishments entered by the user, and the contact information 334 includes contact information for the user, such as email and phone number. The following 316 area includes the name of entities in the social network being followed by the user.

In some example embodiments, the social network is configured to present interesting content on the user feed for the user. However, when a user has just joined the network, the user may not have any friends in the social network nor industry contacts, and may not be following any entity.

In order to generate good content for the user, the social network identifies content in the same industry as the user, and then selects the best content from the same industry for presentation in the user feed. By selecting the best content in the same industry, the user will be interested in the content being posted on the social network and will be encouraged to continue using the social network.

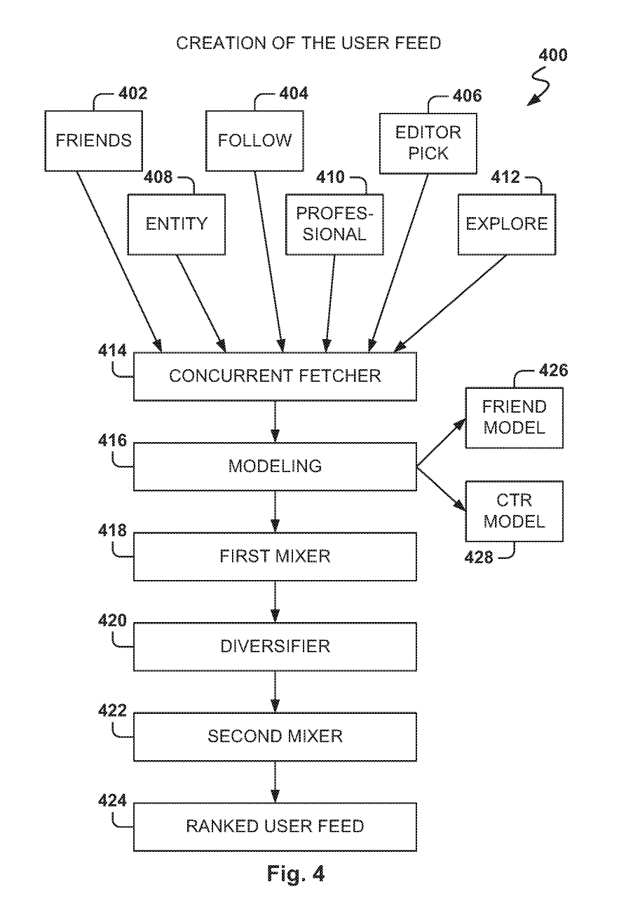

FIG. 4 is a diagram illustrating a method 400 for the creation of the user feed by merging a plurality of content types, according to some example embodiments. While the various operations in this flowchart are presented and described sequentially, one of ordinary skill will appreciate that some or all of the operations may be executed in a different order, be combined or omitted, or be executed in parallel.

A concurrent fetcher 414 fetches the posts from the posts database. The posts may be of multiple types, such as friend's posts 402, which are posts created by friends of the user in the social network; follow posts 404, which are posts created by users in the social network that are being followed by the user; editor-pick posts 406, which are posts selected by the editor of the social network; entity posts 408, which are created by entities in the network, where an entity could be anyone of another member, a company, an educational institution, or an organization, and the entity posts may include posts related to a topic (e.g., as identified by a hashtag), an event, or a group; professional posts 410, which are posts created by users in the same industry of the user; and explore 412 posts, which are posts selected in random areas to increase the variety presented in the user feed.

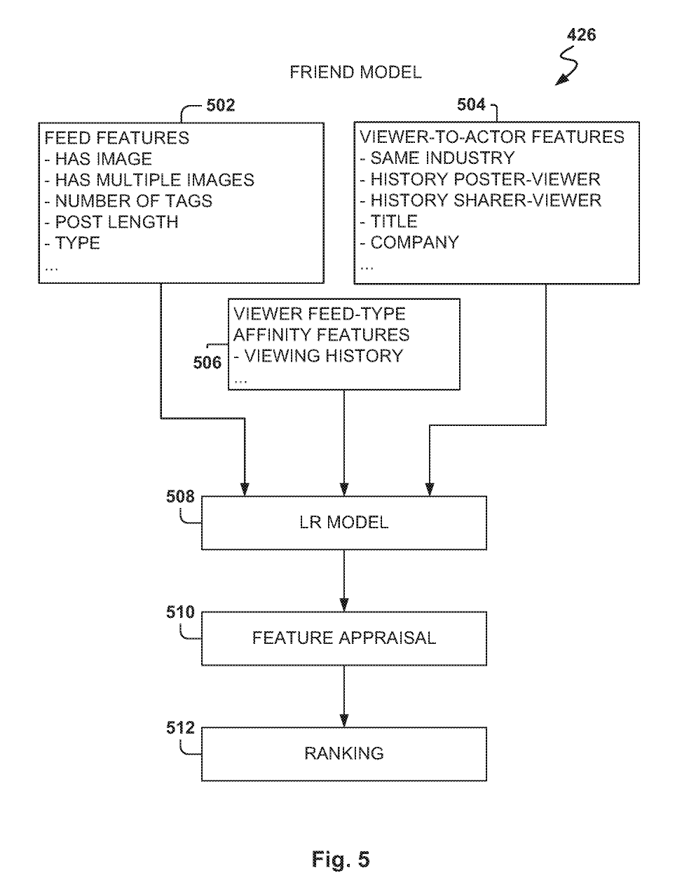

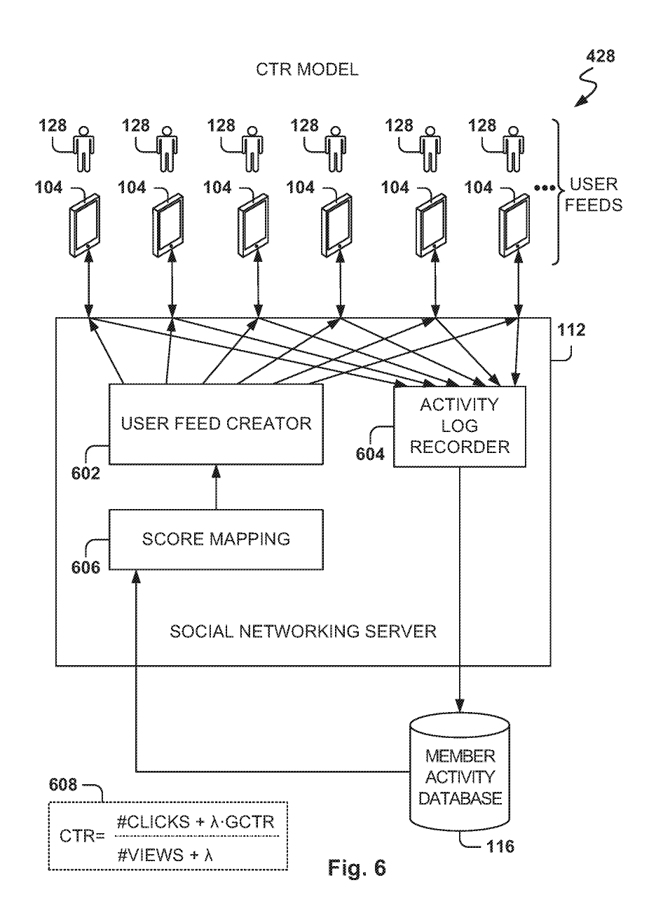

At operation 416, the machine-learning models are utilized to score the posts, and the scores are used to rank content for presentation in the user feed. In one example embodiment, two models are utilized for scoring content: the friend model 426 and the CTR model 428. More details about the friend model 426 are provided below with reference to FIG. 5 and for the CTR model 428 with reference to FIG. 6.

In some example embodiments, the friend model 426 provides a score S_{f} for each friend post and the CTR model 428 provides a score S_{c}. From S_{f} and S_{c}, a global score S, also referred to as the relevance score, is used for ranking the posts. The score S defines the relevance of the posts, and the posts are presented in their relevance order, e.g., their score S order. The score S is, in some example embodiments, a weighted sum of the two scores S_{f} and S_{c}, were S_{f} is weighted with a first weight w_{f} and S_{c} is weighted with a second weight w_{c}. The combined score is then calculated according to the following equation:

S=w_{f}·S_{f}+w_{c}·S_{c}

For example, in one example embodiment, w_{f} is equal to 0.7 and w_{c} is equal to 0.3, and S is calculated as (0.7S_{f}+0.3S_{c}). Other values for w_{f} and w_{c} are also possible depending on the configuration of the system, and the parameters may be tuned over time (e.g., as more CTR data becomes available). The score S is then used to rank the posts.

Other example embodiments may combine S_{f} and S_{c} differently, such as by doing a geometric mean of both values, or utilizing step, exponential, or geometric functions, or by using predefined tables.

After the posts have been assigned scores, at operation 418, a first mixer takes place, where posts are sorted according to their scores, with the posts including friend's posts, follow posts, industry posts, and editor-pick posts.

From operation 418, the method flows to operation 420, where a diversifier module checks the results of the first mix and adds new posts, deletes posts, or changes the priority of existing posts in order to increase the variety of the user feed.

At operation 422, a second mixer may add posts to the feed that are a recommendation for an entity or an explore post at a random position. At operation 424, the ranked user feed, which is the output of the second mixer, is presented to the user on the user feed.

FIG. 5 is a diagram illustrating how to rank the content created by friends, according to some example embodiments. Machine learning is a field of study that gives computers the ability to learn without being explicitly programmed. Machine learning explores the study and construction of algorithms, also referred to herein as tools, that can learn from existing data and make predictions about new data. Such machine-learning tools operate by building a model from example inputs in order to make data-driven predictions or decisions expressed as outputs. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), and Support Vector Machines (SVM) tools may be used for classifying or scoring posts.

In general, there are two types of problems in machine learning: classification problems and regression problems. Classification problems aim at classifying items into one of several categories. For example, is this object an apple or an orange? Regression algorithms aim at quantifying some items, for example by providing a value that is a real number. In our case, example embodiments classify posts to determine if the posts are professional or nonprofessional. In other example embodiments, machine learning is also utilized to provide a score (e.g., a number from 1 to 100) for the quality of a post.

The friend model 426 is a machine-learning algorithm used to score friend's posts. In one embodiment, a linear regression algorithm is utilized, but other embodiments may utilize other machine-learning algorithms.

In one example embodiment, the features used for the friend model 426 include features associated with the posts in feed 502, also referred to as the feed features; viewer-to-actor features 504, which are related to the relationship between the poster and the viewer; and viewer feed-type affinity features 506, which are features related to the posts that the user prefers to view, e.g., related to the viewing history of the user.

The feed 502 features include one or more of the following features: a flag indicating if the post includes an image, a flag indicating that the post includes multiple images, the number of tags in the post, the length of the post (e.g., measured as number of characters or number of words in the post), or the type of the post (e.g., user post, share, editor's pick, etc.).

The viewer-to-actor features 504 include one or more of the following features: whether the viewer and the actor are in the same industry, a history of interactions between the poster and the viewer, a history of interactions between a person that shared and the viewer, the title of the poster, the title of the viewer, the company of the poster, or the company of the viewer.

At operation 508, the friend model is trained. For example, the friend model is trained utilizing judge-entered data, history data, or both. In one example embodiment, when the post is presented to the user, the post receives a label of 1 (e.g., positive) when the user likes, comments on, or shares. Otherwise, the post is designed a label of 0 (e.g., negative). In other embodiments, the post may receive a label selected from a plurality of possible labels.

At operation 510, the features of the friend model are appraised in order to predict the scores of future posts. At operation 512, the posts from friends that are to be presented on the user feed are ranked (e.g., given a score) by the friend model algorithm.

FIG. 6 illustrates the CTR model, according to some example embodiments. The CTR model 428 is a machine-learning algorithm used to score posts that are not friend's posts. The CTR model may be trained utilizing judge-entered data or utilizing historical data on the performance of the posts, or both.

In one example embodiment, the social networking server 112 includes a user feed creator 602, an activity log recorder 604, and a score mapping module 606. The user feed creator 602 sorts the posts for the user feeds based on the scores of the posts available for presentation.

In one example embodiment, the posts are classified as professional or nonprofessional posts utilizing the P/NP tool. After the posts have been classified, the user feed creator 602 selects the professional posts associated with the same industry as the viewer, while discarding the professional posts belonging to other industries. This way, the viewer sees professional posts from the same industry, which should be of higher interest to the viewer, thus providing higher engagement with the social network.

The activity log recorder 604 records the activity of the users as the users interact with the social network application, including accessing the user feed. The activity data is stored in the member activity database 116. The activity data includes the data related to the activity of the user while viewing the user feed, and includes items such as the posts viewed by the user, the likes entered by the user, the links in the posts followed by the user, the comments entered by the user, and so forth.

The score mapping module 606 analyzes the user posts to be presented to the users and provides a score, which translates into a ranking for the user feed. The friend's posts are scored utilizing the friend model discussed above with reference to FIG. 5, and the other posts are scored utilizing the CTR model. In one example embodiment, the CTR model tracks the performance of the posts as the posts are presented in one or more user views. Based on the response from the viewers, the CTR is adjusted.

In one example embodiment, the CTR assigned to a post is calculated utilizing equation 608 as follows:

$$CTR = \frac{CLKS + λ \cdot GCTR}{VIEWS + λ} \qquad ( 608 )$$

Where CLKS is the number of clicks on the post (e.g., to like it, to follow a link, or to share it), and VIEWS is the number of views of the post, that is, how many times the post has been viewed by users. GCTR is a global CTR value obtained from historical data for all the posts, and in one example embodiment, GCTR is equal to the total number of clicks for all posts divided by the number of all post views over a period of time. In another example embodiment, the GCTR is calculated as the historical click-through rate for the viewer.

Further, λ is a tuning parameter used to minimize the effects of lack of data or few available data. For example, if a post is viewed once and the user clicks on the post, the CTR would be a perfect 1, if the CTR were calculated as the number of clicks divided by the number of views. By using λ and the GCTR, the typical post will start with a CTR that is near GCTR, the average historical CTR. After the post has more views, then the CTR will go up and down depending on the post's performance. In some example embodiments, λ is in the range between 10 and 100, but other values are also possible. In some example embodiments, λ is a tunable parameter that can be adjusted periodically based on the performance of the CTR model.

After the friend posts and CTR posts have been assigned a score, the user feed creator 602 prepares the user feed by selecting the posts with the higher scores first, followed by other posts in descending order of the score. In one example embodiment, the professional posts from the same industry as the viewer are selected by the user feed creator 602.

It is noted that the embodiments illustrated in FIG. 6 are exemplary. Other embodiments may utilize different CTR equations, or record different types of activities, or used different equations for different types of content, and the like. The embodiments illustrated in FIG. 6 should therefore not be interpreted to be exclusive or limiting, but rather exemplary or illustrative.

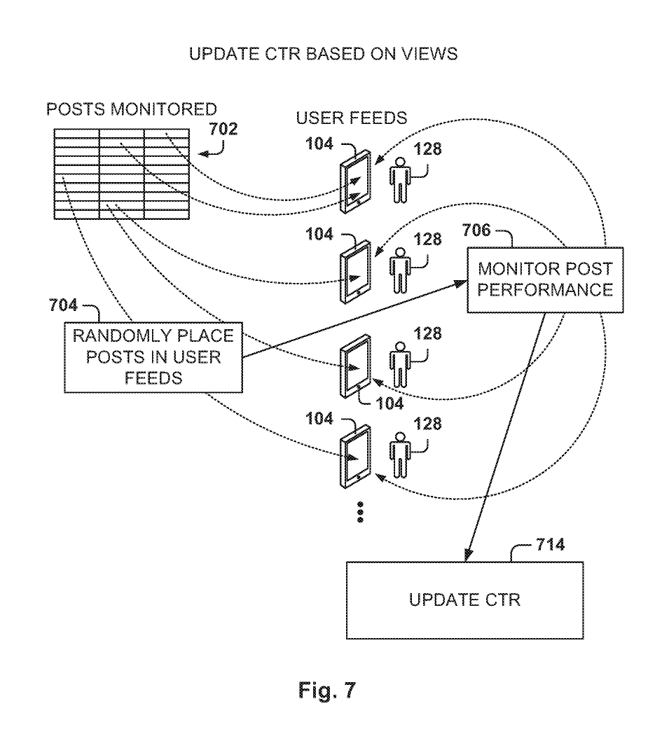

FIG. 7 illustrates the tracking of the CTR, according to some example embodiments. In one example embodiment, a plurality of posts 702 are identified for placing user feeds. In order to evaluate the CTR of the posts 702, the posts are randomly placed 704 in user feeds at client devices 104.

As the users interact with the posts 702, the social networking server monitors the post performance 706, such as by tracking when the user clicks on the post. At operation 714, the CTR of the posts 702 is updated as additional performance information is made available. For example, the CTR is updated utilizing equation 608 of FIG. 6.

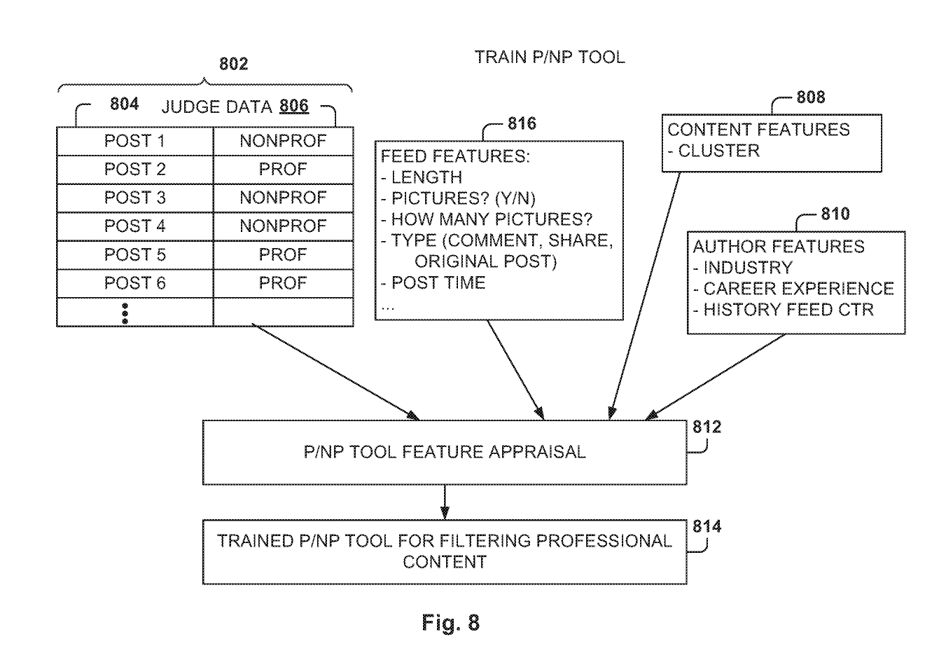

FIG. 8 is a diagram illustrating the method for training the P/NP tool, according to some example embodiments. The P/NP tool gives an answer to the question, “Is this post a professional post or a nonprofessional post?”

In one example embodiment, judge data is utilized to train the SNP tool (as illustrated in FIG. 8). In another example embodiments, the training data includes historical data, including a plurality of professional posts and the corresponding scores (e.g., the CTR).

Initially, judge data 802 is collected. As used herein, a judge is a person, also referred to as an editor, who reads a post and classifies the post according to one of the available categories. In one example embodiment, the judges examine each post 804 and assign a category 806 to the post as either professional or nonprofessional. In another example embodiment, category data is received from users of the social network.

In one example embodiment, the features identified for the P/NP tool include feed features 816, content features 808, and author features 810. The features are used to train the machine-learning P/NP tool, and then the machine-learning P/NP tool is used to classify the posts.

The feed features 816 are related to the content of the posts and include one or more of the following:
a length of the text in the post (e.g., measured as number of characters or number of words);
a flag indicating if the post includes pictures or not;
the number of pictures in the post;
a type of the post (e.g., comment, share, or original post);
a time when the post was created;

etc.

The content features 808 are also related to the content of the post, more specifically, to the semantic content of the post. In one embodiment, the content features 808 include a machine-learned post cluster identifier (CID) that is trained from the text in the post and the text in shared content (for example, if a user shares an article or another user's post, the text in the shared content).

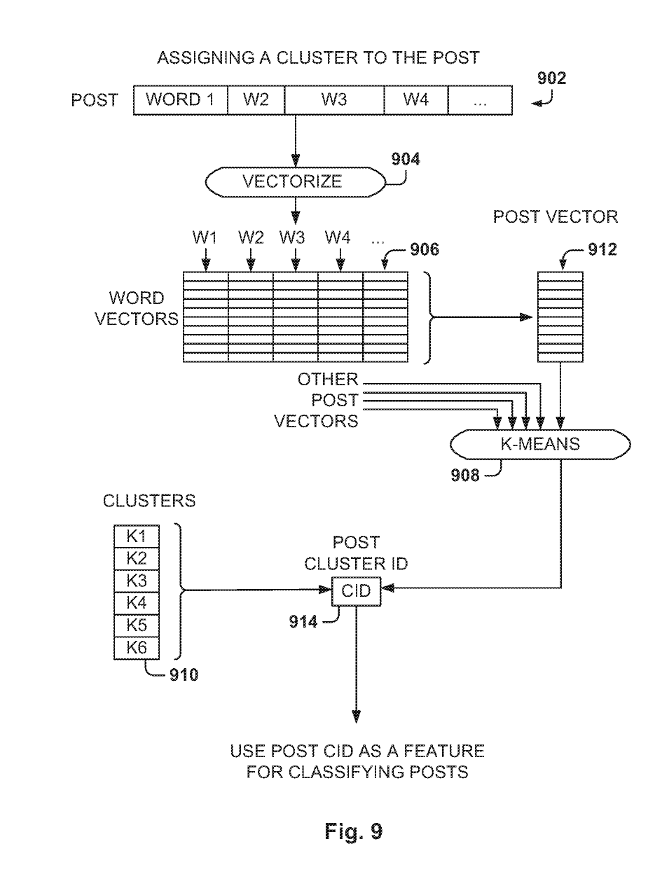

It is to be noted that one of the most challenging parts of evaluating features for classification is the evaluation of the content (e.g., text) in the post. Simply using words as a feature may be less effective because many words have synonyms, and some words have multiple semantic meanings. This is why, in some example embodiments, the semantic meaning of each word is utilized as the feature. More details are provided below with reference to FIG. 9 on how to identify the semantic meaning of each word and estimate the semantic meaning of the post.

The author features 810 are related to the information about the author that created the post. In one embodiment, the author features 810 include one or more of the following:
an industry of the author, as registered in the profile of the author in the social network;
the career experience in the profile of the author;
historical CTR on posts created by the author;
a connection strength between the viewer and the poster, where the connection strength is based on the level of activity in the social network between the poster and the viewer;
a historical relationship between the viewer and the poster who created the post;
other information in the profile of the author;
and the like.

At operation 812, the P/NP tool is executed to appraise the features based on the judge data 802. At operation 814, the P/NP tool is trained for filtering content to classify posts as professional posts or nonprofessional posts.

It is noted that the embodiments illustrated in FIG. 8 are exemplary. Other embodiments may utilize different features, additional features, fewer features, and so forth. The embodiments illustrated in FIG. 8 should therefore not be interpreted to be exclusive or limiting, but rather exemplary or illustrative.

FIG. 9 is a diagram illustrating the assignment of the post to a cluster, according to one example embodiment. Using the text in the post as a feature for classifying professional or nonprofessional content is challenging. For example, an LR algorithm may be used for other features, but LR is harder for text since words may mean different things according to the context in which the words are used.

In order to include a feature correlated to the semantic meaning of the post, the words of the post are classified according to their semantic meaning, and then their semantic meaning is used to classify the post into one of a plurality of clusters.

First, the post 902 is parsed to identify the words in the post 902. In the English language, this is a straightforward proposition, but parsing is more complex in other languages like Chinese, where there are no spaces between words acting as delimiters.

At operation 904, each word is vectorized, which means that a high-dimensional vector 906 is assigned to each word, where each vector 906 is correlated with a semantic meaning of the word. In one example embodiment, the tool Word2vec is utilized for the vectorization operation 904, but other tools such as Latent Dirichlet Allocation (LDA) may also be utilized.

Word2vec is a group of related models that are used to produce word embeddings. These models are shallow, two-layer neural networks that are trained to reconstruct linguistic contexts of words. Word2vec takes as input a large corpus of text and produces a high-dimensional space (typically between a hundred and several hundred dimensions). Each unique word in the corpus is assigned a corresponding vector 906 in the space. The vectors 906 are positioned in the vector space such that words that share common contexts in the corpus are located in close proximity to one another in the space. In one example embodiment, each element of the vector 906 is a real number.

For example, Word2vec may be utilized to identify the similarity between two words. In one example, a large number of titles were used as input, and a list was created of words having a similar meaning to the word “software.” The list included the misspelling “sofware” with an indicated probability of being related to “software” of 0.8110, and the word “android” with a probability of 0.6615.

After the word vectors 906 are created, a post vector 912 is created based on the word vectors 906. In one example embodiment, the post vector 912 is the average of the word vectors 906, but other equations are also possible. The post vector 912 is used as an input to a tool that classifies the posts vectors into corresponding clusters, according to the proximity between the post vectors. In one example embodiment, K-means clustering 908 is used to assign the post to one of a plurality of clusters.

K-means clustering is a method of vector quantization, originally used in signal processing, that is popular for cluster analysis in data mining. K-means clustering aims to partition n observations into k clusters, where each observation belongs to the cluster with the nearest mean, serving as a prototype of the cluster. This results in a partitioning of the data space into Voronoi cells.

In some example embodiments, the number of clusters is between 5 and 10, but other embodiments may utilize between 5 and 100 clusters or more. In one example embodiment of an implementation in the Chinese language, some of the clusters identified included a life-style cluster, a cluster for sharing professional content, a cluster for advertisements and job postings, and a cluster for posts written in English.

The result of the K-means clustering 908 is the post CID 914. In the exemplary embodiment of FIG. 9, the use of six clusters K1-K6 910 is illustrated. Therefore, the post CID 914 is one of the six clusters K1-K6 910.

In one example embodiment, the post CID 914 is used as a feature for the P/NP tool. Since the vectorization of the words is performed based on the semantic meaning of the words and the post vector 912 is based on the semantic meaning of the words in the post, the cluster or topic for the post is likewise associated with the semantic meaning of the post. This semantic meaning of the post enhances the classification algorithm of the P/NP tool.

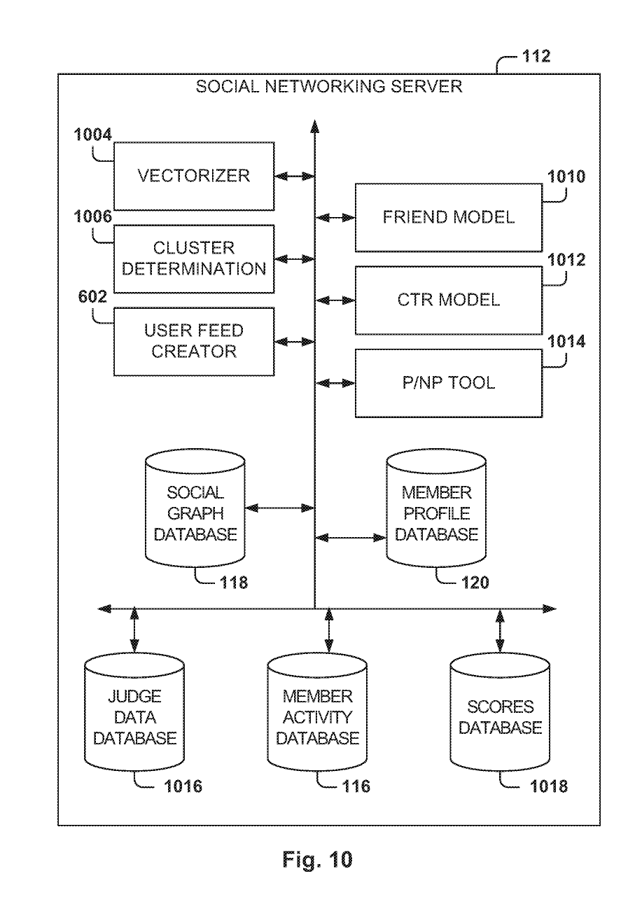

FIG. 10 illustrates the social networking server 112 that provides access to user feeds, according to one example embodiment. In one example embodiment, the social networking server 112 includes a plurality of tools for managing the user feed and a plurality of databases. The plurality of tools for managing the user feed include a vectorizer 1004, a cluster determination module 1006, a user feed creator 602, the friend model 1010 tool, the CTR model 1012 tool, and the P/NP tool 1014.

The vectorizer 1004 takes a post as an input, parses the words of the post, and creates a vector for each word of the post. In one embodiment, the vectorizer utilizes the Word2vec tool, as described above with reference to FIG. 9.

The cluster determination module 1006 takes the word vectors as inputs, calculates the post vectors based on the word vectors of the words in each post, and assigns each post to a cluster from a plurality of clusters. In one embodiment, the cluster determination module 1006 utilizes K-means clustering, as described above with reference to FIG. 9.

The user feed creator 602 creates the user feed 202 for presentation on the user interface of the client device, as described above with reference to FIG. 6. The friend model 1010 determines the score of friends' posts utilizing a machine-learning algorithm based on a plurality of features, as illustrated above with reference to FIG. 5.

The CTR model 1012 tool determines the score of industry posts utilizing a machine-learning algorithm based on a plurality of features, such as the features described above with reference to FIG. 6.

The P/NP tool 1014 classifies posts as professional posts or nonprofessional posts utilizing a machine-learning algorithm based on a plurality of features, such as the features described above with reference to FIG. 8.

It is to be noted that the embodiments illustrated in FIG. 10 are exemplary. Other embodiments may utilize different modules or machine-learning algorithms, combine the functionality of two modules into one module, distribute the functionality of one module across a plurality of servers, etc. The embodiments illustrated in FIG. 10 should therefore not be interpreted to be exclusive or limiting, but rather exemplary or illustrative.

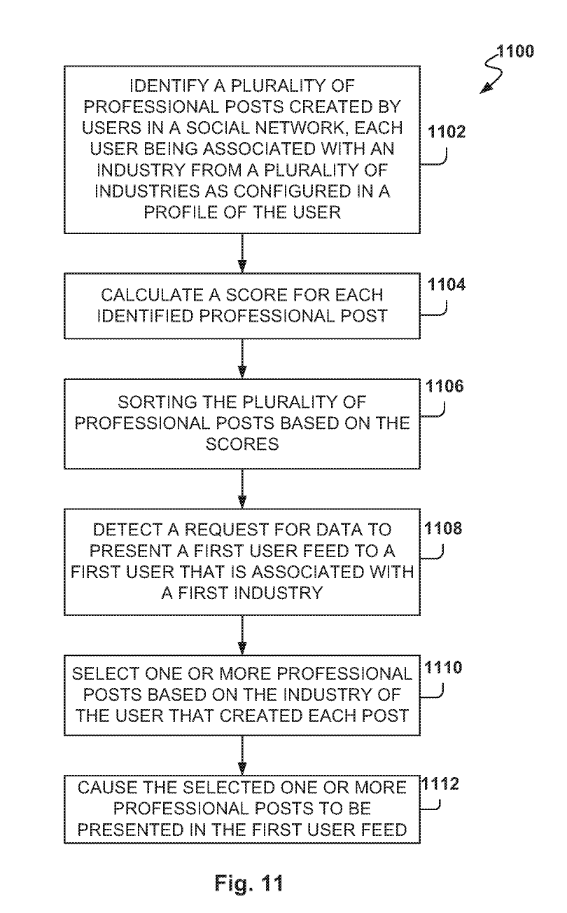

FIG. 11 is a flowchart of a method 1100, according to some example embodiments, for presenting professional content in a user feed of a social network. While the various operations in this flowchart are presented and described sequentially, one of ordinary skill will appreciate that some or all of the operations may be executed in a different order, be combined or omitted, or be executed in parallel.

At operation 1102, the server, which includes a processor, identifies a plurality of professional posts created by users in the social network. Each user is associated with an industry from a plurality of industries as configured in a profile of the user. From operation 1102, the method flows to operation 1104, where the server calculates a score for each identified professional post.

At operation 1106, the server sorts the plurality of professional posts based on the scores. At operation 1108, the server detects a request for data to present a first user feed to a first user that is associated with a first industry.

From operation 1108, the method flows to operation 1110, where the server selects one or more professional posts based on the industry of the user that created each post. For example, if the user is in the information technology industry, the server selects posts created by users affiliated to the information technology industry. At operation 1112, the server causes the selected one or more professional posts to be presented in the first user feed.

In one example embodiment, the score is calculated for each identified professional post by: randomly placing test professional posts in user feeds of random users of the social network, measuring a performance of each test professional post based on a response from the random users of the social network, and predicting the scores of the professional posts based on the measured performance. In another example embodiment, the score of each test professional post is based on a click-through rate for the test professional post.

Further, in some example embodiments, the sorting of the plurality of professional posts further includes sorting the professional posts in decreasing order of the scores of the professional posts, where professional posts with higher scores are presented ahead of professional posts with lower scores. In one aspect, the first industry is configured in the profile of the first user.

In one example embodiment, the method 1100 further includes training a machine-learning classifier to classify posts of the social network as professional posts or nonprofessional posts based on a plurality of features. In one aspect, the plurality of features include one or more of: a cluster from a plurality of clusters assigned to each post; a length of the post; whether the post includes a picture; a type of the post selected from a comment, a share, or an original post; a reputation of a poster of the post; and a time of posting.

In one example embodiment, the method 1100 further includes merging the professional posts with nonprofessional posts into the first user feed before presenting the first user feed to the first user. In one example embodiment, the professional posts are associated with a professional activity of a poster of each post, where the nonprofessional posts are not associated with the professional activity of the poster of each post. In one example embodiment, the scores for the nonprofessional posts are determined by a machine-learning algorithm based on at least one or more features selected from a group consisting of: a historical relationship between a viewer and a poster, a connection strength between the viewer and the poster, a type of the post, text in the post, a length of the post, a profile of the poster, and a profile of the viewer.

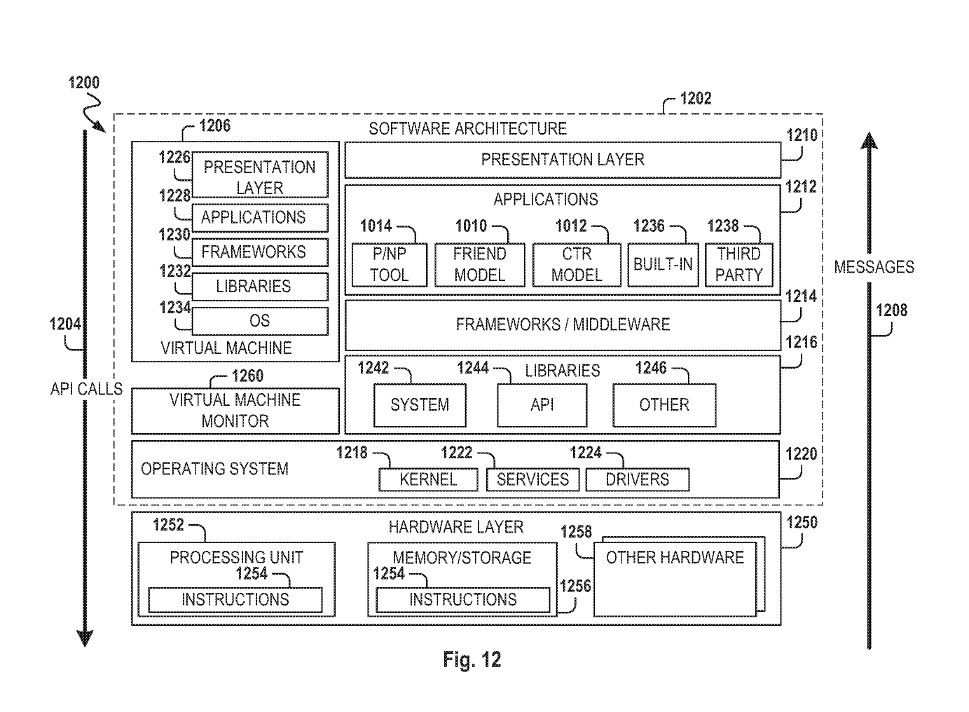

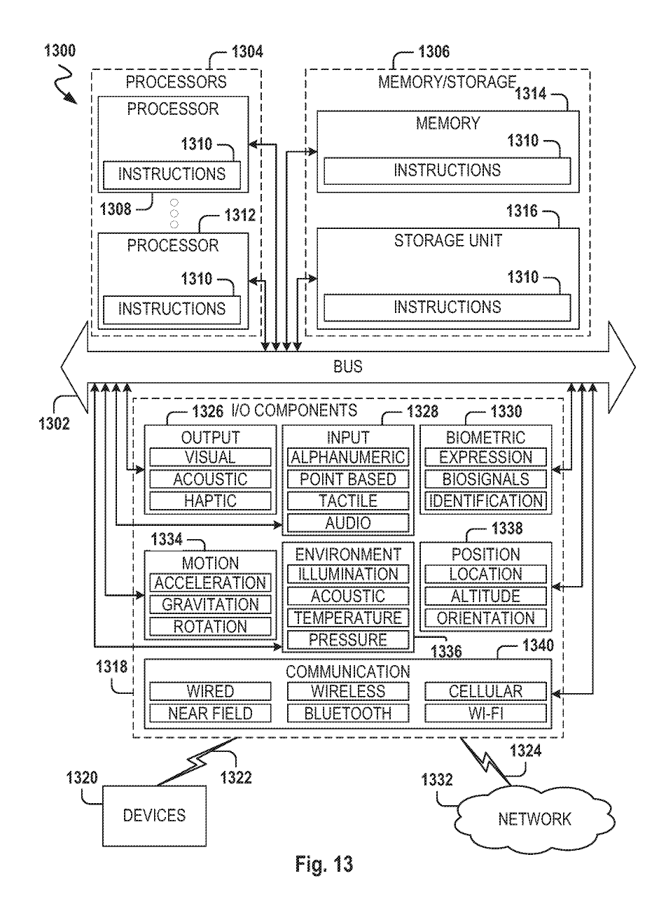

FIG. 12 is a block diagram 1200 illustrating a representative software architecture 1202, which may be used in conjunction with various hardware architectures herein described. FIG. 12 is merely a non-limiting example of a software architecture 1202 and it will be appreciated that many other architectures may be implemented to facilitate the functionality described herein. The software architecture 1202 may be executing on hardware such as a machine 1300 of FIG. 13 that includes, among other things, processors 1304, memory/storage 1306, and input/output (I/O) components 1318. A representative hardware layer 1250 is illustrated and can represent, for example, the machine 1300 of FIG. 13. The representative hardware layer 1250 comprises one or more processing units 1252 having associated executable instructions 1254. The executable instructions 1254 represent the executable instructions of the software architecture 1202, including implementation of the methods, modules and so forth of FIGS. 1-11. The hardware layer 1250 also includes memory and/or storage modules 1256, which also have the executable instructions 1254. The hardware layer 1250 may also comprise other hardware 1258 which represents any other hardware of the hardware layer 1250, such as the other hardware illustrated as part of the machine 1300.

In the example architecture of FIG. 12, the software architecture 1202 may be conceptualized as a stack of layers where each layer provides particular functionality. For example, the software architecture 1202 may include layers such as an operating system 1220, libraries 1216, frameworks/middleware 1214, applications 1212, and a presentation layer 1210. Operationally, the applications 1212 and/or other components within the layers may invoke API calls 1204 through the software stack and receive a response, returned values, and so forth illustrated as messages 1208 in response to the API calls 1204. The layers illustrated are representative in nature and not all software architectures have all layers. For example, some mobile or special purpose operating systems may not provide a frameworks/middleware layer 1214, while others may provide such a layer. Other software architectures may include additional or different layers.

The operating system 1220 may manage hardware resources and provide common services. The operating system 1220 may include, for example, a kernel 1218, services 1222, and drivers 1224. The kernel 1218 may act as an abstraction layer between the hardware and the other software layers. For example, the kernel 1218 may be responsible for memory management, processor management (e.g., scheduling), component management, networking, security settings, and so on. The services 1222 may provide other common services for the other software layers. The drivers 1224 may be responsible for controlling or interfacing with the underlying hardware. For instance, the drivers 1224 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1216 may provide a common infrastructure that may be utilized by the applications 1212 and/or other components and/or layers. The libraries 1216 typically provide functionality that allows other software modules to perform tasks in an easier fashion than to interface directly with the underlying operating system 1220 functionality (e.g., kernel 1218, services 1222, and/or drivers 1224). The libraries 1216 may include system libraries 1242 (e.g., C standard library) that may provide functions such as memory allocation functions, string manipulation functions, mathematic functions, and the like. In addition, the libraries 1216 may include API libraries 1244 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1216 may also include a wide variety of other libraries 1246 to provide many other APIs to the applications 1212 and other software components/modules.

The frameworks 1214 (also sometimes referred to as middleware) may provide a higher-level common infrastructure that may be utilized by the applications 1212 and/or other software components/modules. For example, the frameworks 1214 may provide various graphic user interface (GUI) functions, high-level resource management, high-level location services, and so forth. The frameworks 1214 may provide a broad spectrum of other APIs that may be utilized by the applications 1212 and/or other software components/modules, some of which may be specific to a particular operating system or platform.

The applications 1212 include the friend model 1010 tool, the CTR model 1012 tool, the P/NP tool 1014, built-in applications 1236, and/or third-party applications 1238. Examples of representative built-in applications 1236 may include, but are not limited to, a contacts application, a browser application, a book reader application, a location application, a media application, a messaging application, and/or a game application. The third-party applications 1238 may include any of the built-in applications 1236 as well as a broad assortment of other applications. In a specific example, the third-party application 1238 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1238 may invoke the API calls 1204 provided by the mobile operating system such as the operating system 1220 to facilitate functionality described herein.

The applications 1212 may utilize built-in operating system functions (e.g., kernel 1218, services 1222, and/or drivers 1224), libraries (e.g., system libraries 1242, API libraries 1244, and other libraries 1246), or frameworks/middleware 1214 to create user interfaces to interact with users of the system. Alternatively, or additionally, in some systems, interactions with a user may occur through a presentation layer, such as the presentation layer 1210. In these systems, the application/module “logic” can be separated from the aspects of the application/module that interact with a user.

Some software architectures utilize virtual machines. In the example of FIG. 12, this is illustrated by a virtual machine 1206. A virtual machine creates a software environment where applications/modules can execute as if they were executing on a hardware machine (such as the machine 1300 of FIG. 13, for example). The virtual machine 1206 is hosted by a host operating system (e.g., operating system 1220 in FIG. 12) and typically, although not always, has a virtual machine monitor 1260, which manages the operation of the virtual machine 1206 as well as the interface with the host operating system (e.g., operating system 1220). A software architecture executes within the virtual machine 1206 such as an operating system 1234, libraries 1232, frameworks/middleware 1230, applications 1228, and/or a presentation layer 1226. These layers of software architecture executing within the virtual machine 1206 can be the same as corresponding layers previously described or may be different.

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1310 (e.g., software, a program, an application, an applet, an app, or other executable code) for causing the machine 1300 to perform any one or more of the methodologies discussed herein may be executed. For example, the instructions 1310 may cause the machine 1300 to execute the flow diagrams of FIGS. 4-12. Additionally, or alternatively, the instructions 1310 may implement the model tools of FIGS. 4-12, and so forth. The instructions 1310 transform the general, non-programmed machine 1300 into a particular machine 1300 programmed to carry out the described and illustrated functions in the manner described.

In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a switch, a controller, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1310, sequentially or otherwise, that specify actions to be taken by the machine 1300. Further, while only a single machine 1300 is illustrated, the term “machine” shall also be taken to include a collection of machines 1300 that individually or jointly execute the instructions 1310 to perform any one or more of the methodologies discussed herein.

The machine 1300 may include processors 1304, memory/storage 1306, and I/O components 1318, which may be configured to communicate with each other such as via a bus 1302. In an example embodiment, the processors 1304 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1308 and a processor 1312 that may execute the instructions 1310. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single core, a single processor with multiple cores (e.g., a multi-core processor), multiple processors with a single core, multiple processors with multiples cores, or any combination thereof.

The memory/storage 1306 may include a memory 1314, such as a main memory, or other memory storage, and a storage unit 1316, both accessible to the processors 1304 such as via the bus 1302. The storage unit 1316 and memory 1314 store the instructions 1310 embodying any one or more of the methodologies or functions described herein. The instructions 1310 may also reside, completely or partially, within the memory 1314, within the storage unit 1316, within at least one of the processors 1304 (e.g., within the processor's cache memory), or any suitable combination thereof, during execution thereof by the machine 1300. Accordingly, the memory 1314, the storage unit 1316, and the memory of the processors 1304 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1310. The term “machine-readable medium” shall also be taken to include any medium, or combination of multiple media, that is capable of storing instructions (e.g., instructions 1310) for execution by a machine (e.g., machine 1300), such that the instructions, when executed by one or more processors of the machine (e.g., processors 1304), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1318 may include a wide variety of components to receive input, provide output, produce output, transmit information, exchange information, capture measurements, and so on. The specific I/O components 1318 that are included in a particular machine will depend on the type of machine. For example, portable machines such as mobile phones will likely include a touch input device or other such input mechanisms, while a headless server machine will likely not include such a touch input device. It will be appreciated that the I/O components 1318 may include many other components that are not shown in FIG. 13. The I/O components 1318 are grouped according to functionality merely for simplifying the following discussion, and the grouping is in no way limiting. In various example embodiments, the I/O components 1318 may include output components 1326 and input components 1328. The output components 1326 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1328 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1318 may include biometric components 1330, motion components 1334, environmental components 1336, or position components 1338 among a wide array of other components. For example, the biometric components 1330 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1334 may include acceleration sensor components (e.g., accelerometer), gravitation sensor components, rotation sensor components (e.g., gyroscope), and so forth. The environmental components 1336 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1338 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1318 may include communication components 1340 operable to couple the machine 1300 to a network 1332 or devices 1320 via a coupling 1324 and a coupling 1322, respectively. For example, the communication components 1340 may include a network interface component or other suitable device to interface with the network 1332. In further examples, the communication components 1340 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1320 may be another machine or any of a wide variety of peripheral devices (e.g., a peripheral device coupled via a USB).

Moreover, the communication components 1340 may detect identifiers or include components operable to detect identifiers. For example, the communication components 1340 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1340, such as location via Internet Protocol (IP) geo-location, location via Wi-Fi® signal triangulation, location via detecting an NFC beacon signal that may indicate a particular location, and so forth.

In various example embodiments, one or more portions of the network 1332 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1332 or a portion of the network 1332 may include a wireless or cellular network and the coupling 1324 may be a Code Division Multiple Access (CDMA) connection, a Global System for Mobile communications (GSM) connection, or another type of cellular or wireless coupling. In this example, the coupling 1324 may implement any of a variety of types of data transfer technology, such as Single Carrier Radio Transmission Technology (1×RIT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1310 may be transmitted or received over the network 1332 using a transmission medium via a network interface device (e.g., a network interface component included in the communication components 1340) and utilizing any one of a number of well-known transfer protocols (e.g., hypertext transfer protocol (HTTP)). Similarly, the instructions 1310 may be transmitted or received using a transmission medium via the coupling 1322 (e.g., a peer-to-peer coupling) to the devices 1320. The term “transmission medium” shall be taken to include any intangible medium that is capable of storing, encoding, or carrying the instructions 1310 for execution by the machine 1300, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
identifying, by a server that includes a processor, a plurality of professional posts created by users in a social network, each user being associated with an industry from a plurality of industries as configured in a profile of the user;
calculating, by the server, a score for each identified professional post;
sorting the plurality of professional posts based on the scores;
detecting, by the server, a request for data to present a first user feed to a first user that is associated with a first industry;
selecting, by the server, one or more professional posts based on the industry of the user that created each post; and
causing the selected one or more professional posts to be presented in the first user feed.

2. The method as recited in claim 1, wherein the calculating the score for each identified professional post further comprises:
randomly placing test professional posts in user feeds of random users of the social network; and
measuring a performance of each test professional post based on a response from the random users of the social network.

3. The method as recited in claim 2, further comprising:
training a first machine-learning algorithm based on the measured performance of the randomly placed test professional posts; and
predicting the scores of the professional posts utilizing the first-machine learning algorithm.

4. The method as recited in claim 3, wherein the first machine-learning algorithm analyzes a plurality of features that comprise one or more of: a cluster from a plurality of clusters assigned to each post; a length of the post; whether the post includes a picture or not; a type of the post selected from a comment, a share, or an original post; a reputation of a poster of the post; an industry of the poster; a historical click-through rate of the poster; and a time of posting.

5. The method as recited in claim 2, wherein the score of each test professional post is based on a click-through rate for the test professional post.

6. The method as recited in claim 1, wherein the sorting of the plurality of professional posts further comprises:
sorting the professional posts in decreasing order of the scores of the professional posts, wherein professional posts with higher scores are presented ahead of professional posts with lower scores.

7. The method as recited in claim 1, wherein the first industry is configured in the profile of the first user.

8. The method as recited in claim 1, further comprising:
training a machine-learning classifier to classify posts of the social network as professional posts or nonprofessional posts based on a plurality of features.

9. The method as recited in claim 8, wherein the plurality of features comprise one or more of: a cluster from a plurality of clusters assigned to each post; a length of the post; whether the post includes a picture or not; a type of the post selected from a comment, a share, or an original post; a reputation of a poster of the post; and a time of posting.

10. The method as recited in claim 1, further comprising:
merging the professional posts with nonprofessional posts into the first user feed before presenting the first user feed to the first user.

11. The method as recited in claim 10, wherein the professional posts are associated with a professional activity of a poster of each post, wherein the nonprofessional posts are not associated with the professional activity of the poster of each post.

12. The method as recited in claim 10, wherein scores for the nonprofessional posts are determined by a second machine-learning algorithm based on at least one or more features selected from a group consisting of: a historical relationship between a viewer and a poster, a connection strength between the viewer and the poster, a type of the post, text in the post, a length of the post, a profile of the poster, and a profile of the viewer.

13. A server comprising:
a memory comprising instructions; and
one or more computer processors, wherein the instructions, when executed by the one or more computer processors, cause the one or more computer processors to perform operations comprising:
identifying a plurality of professional posts created by users in a social network, each user being associated with an industry from a plurality of industries as configured in a profile of the user;
calculating a score for each identified professional post;
sorting the plurality of professional posts based on the scores;
detecting a request for data to present a first user feed to a first user that is associated with a first industry;
selecting one or more professional posts based on the industry of the user that created each post; and
causing the selected one or more professional posts to be presented in the first user feed.

14. The server as recited in claim 13, wherein the calculating the score for each identified professional post further comprises:
randomly placing test professional posts in user feeds of random users of the social network; and
measuring a performance of each test professional post based on a response from the random users of the social network.

15. The server as recited in claim 14, wherein the instructions further cause the one or more processors to perform operations comprising:
training a first machine-learning algorithm based on the measured performance of the randomly placed test professional posts; and
predicting the scores of the professional posts utilizing the first-machine learning algorithm.

16. The server as recited in claim 15, wherein the first machine-learning algorithm analyzes a plurality of features that comprise one or more of: a cluster from a plurality of clusters assigned to each post; a length of the post; whether the post includes a picture or not; a type of the post selected from a comment, a share, or an original post; a reputation of a poster of the post; an industry of the poster; a historical click-through rate of the poster; and a time of posting.

17. The server as recited in claim 13, wherein the sorting of the plurality of professional posts further comprises:
sorting the professional posts in decreasing order of the scores of the professional posts, wherein professional posts with higher scores are presented ahead of professional posts with lower scores.

18. The server as recited in claim 13, wherein the instructions further cause the one or more processors to perform operations comprising:
training a machine-learning classifier to classify posts of the social network as professional posts or nonprofessional posts based on a plurality of features.

19. The server as recited in claim 13, wherein the instructions further cause the one or more processors to perform operations comprising:
training a machine-learning scoring algorithm to predict scores for the professional posts; and
utilizing the machine-learning scoring algorithm to calculate the scores for the professional posts.

20. A non-transitory machine-readable storage medium including instructions that, when executed by a machine, cause the machine to perform operations comprising:
identifying, by a server, a plurality of professional posts created by users in a social network, each user being associated with an industry from a plurality of industries as configured in a profile of the user, the identified plurality of professional posts being created by users associated with a first industry;
calculating, by the server, a score for each identified professional post;
sorting the plurality of professional posts based on the scores, the sorted plurality of professional posts starting with a professional post having a best score;
detecting, by the server, a request for data to present a first user feed to a first user that is associated with the first industry;
selecting, by the server, one or more professional posts from a start of the sorted plurality of professional posts; and
causing the selected one or more professional posts to be presented in the first user feed.

21. The machine-readable storage medium as recited in claim 20, wherein the calculating the score for each identified professional post further comprises:
randomly placing test professional posts in user feeds of random users of the social network; and
measuring a performance of each test professional post based on a response from the random users of the social network.

22. The machine-readable storage medium as recited in claim 21, wherein the machine further performs operations comprising:
training a first machine-learning algorithm based on the measured performance of the randomly placed test professional posts; and
predicting the scores of the professional posts utilizing the first-machine learning algorithm.

23. The machine-readable storage medium as recited in claim 22, wherein the first machine-learning algorithm analyzes a plurality of features that comprise one or more of: a cluster from a plurality of clusters assigned to each post; a length of the post; whether the post includes a picture or not; a type of the post selected from a comment, a share, or an original post; a reputation of a poster of the post; an industry of the poster; a historical click-through rate of the poster; and a time of posting.

24. The machine-readable storage medium as recited in claim 20, wherein the sorting of the plurality of professional posts further comprises:
sorting the professional posts in decreasing order of the scores of the professional posts, wherein professional posts with higher scores are presented ahead of professional posts with lower scores.

25. The machine-readable storage medium as recited in claim 20, wherein the instructions further cause the machine to perform operations comprising:
training a machine-learning scoring algorithm to predict scores for the professional posts; and
utilizing the machine-learning scoring algorithm to calculate the scores for the professional posts.

26. The machine-readable storage medium as recited in claim 20, wherein the machine further performs operations comprising:
merging the professional posts with nonprofessional posts, follow posts, editor-pick posts, explore posts, and entity posts into the first user feed before presenting the first user feed to the first user.
